(19) United States
(12) Patent Application Publication
(10) Pub. No.: US 2003/0152038 A1
(43) Pub. Date: Aug. 14, 2003

(54) Router, network system, and network setup method

(76) Inventors: Tomohiro Oshima, Fukuoka-shi (JP); Shuzo Ozaki, Fukuoka (JP); Toshihiro Inoue, Fukuoka (JP); Shunji Shinano, Fukuoka (JP)

Correspondence Address: RATNERPRESTIA, P O BOX 980, VALLEY FORGE, PA, 19482-0980, US

(21) Appl. No.: 10/329,088

(22) Filed: Dec. 23, 2002

(30) Foreign Application Priority Data
Dec. 28, 2001 (JP) 2001-400155

(51) Int. Cl. H04L 12/26

(52) U.S. Cl. 370/252; 370/392

(57) ABSTRACT

A router facilitate a network setup including a Port No., and a network system employs the router. The router receives a transmission packet containing a MAC address broadcast from a terminal in a network. The router then relates the IP address and Port No. to the MAC address and store them as network information. The IP address and Port No. are different from those of a terminal already setup. This network information is sent by designating the MAC address. When a transmission packet designating Port No. of the terminal is received from an external network, the router forwards the transmission packet to the terminal whose Port No. stored matches the designated Port No.

### FIELD OF THE INVENTION

The present invention relates to a router used in a private network connected to external network such as the Internet, and network systems using the router.

### BACKGROUND OF THE INVENTION

A range of settings, including Internet Protocol (IP) addresses, are necessary for connecting terminals such as personal computers to private networks. These settings require technical knowledge of networks, and therefore users often cannot set systems up by their own easily. However, the use of Dynamic Host Configuration Protocol (DHCP) enables the setting of IP addresses and the control of all connected terminals by simply connecting a terminal to a network. DHCP includes an automatic assignment mode that automatically and permanently allocates an IP address to the terminal same as in Bootstrap Protocol (BOOTP) and a dynamic assignment mode that allocates an IP address for a limited period or until the terminal releases it.

For example, when a private network is established using several terminals and a router, the router acts as a DHCP server and terminals act as DHCP clients. In this network, each terminal transmits a DHCP packet to the router when the terminal is connected to the router. The router then provides settings including the IP address, subnet mask, and the address of the Domain Name System (DNS) server to the respective terminals.

In the automatic assignment mode, however, the IP address, once provided, cannot be withdrawn. In the dynamic assignment mode, the IP address, once provided, may be changed dynamically. Accordingly, DHCP is not suitable for networks to which numerous terminals are alternately linked and detached.

When an external computer connected to the Internet attempts to gain access to a private network, the external computer needs to access the terminal through the router. This requires the global IP address of the router and the Port No. of the terminal to be accessed.

A specific case is given below.

1) Image servers are connected to the private network as clients.

2) An external computer connected to the Internet directly accesses these image servers through the router.

3) The external computer receives image data in the form of a Hyper Text Markup Language (HTML) file from these image servers.

In the above case, the external computer first inputs and sends the Uniform Resource Location (URL) of the router and the Port No. of one of the image servers in the private network to a web browser. For example, if the URL of the router is camera.co.jp and the Port No. of the target image server is 81, http//www.camera.cojp:81/ is input. The router then receives this transmission packet. The IP address is related to the Port No. of the image server connected to the private network, and this information is stored in the router in advance. Accordingly, the router forwards the transmission packet to the image server that has the IP address related to the destination Port No. of the transmission packet received in the router. This enables the image server to receive the transmission packet sent from the computer on the Internet. When the computer on the Internet wishes to view an image on another image server in the private network, it can access a different image server by designating the Port No. of that image server in the same way.

In the router of the prior art as described above, the IP address can be automatically provided, but not the Port No. This prevents the external computer from directly accessing a specific terminal through the router if several terminals having the same initial Port No. are connected to the private network. This happens because terminals have the same Port No. even though their IP addresses are different.

### SUMMARY OF THE INVENTION

A router of the present invention receives a transmission packet including a Media Access Control (MAC) address broadcast from a terminal in a private network, and stores network information, in which an IP address and Port No. different from preset information in the terminal are related to the MAC address, in a memory. A network system of the present invention is configured using the router. Furthermore, a method of the present invention assigns an IP address and Port No. automatically to the terminal according to the above procedures.

### BRIEF DESCRIPTION OF THE DRAWINGS

FIG. 1 is a configuration of a network including a router in accordance with a preferred embodiment of the present invention.

FIG. 2 is a function block diagram of the router in accordance with a preferred embodiment of the present invention.

FIG. 3 is a function block diagram of the terminal connected to the network in accordance with the preferred embodiment of the present invention.

FIG. 4 is a sequence chart for automatic setup in accordance with the preferred embodiment of the present invention.

FIG. 5 illustrates automatic setup information stored in a memory of the router in accordance with the preferred embodiment of the present invention.

FIG. 6 is a transmission packet structure for the automatic setup sent from the router in accordance with the preferred embodiment of the present invention.

FIG. 7 is an image server setup screen in accordance with the preferred embodiment of the present invention.

FIG. 8 is a sequence chart for an operation against an external access to the router in accordance with the preferred embodiment of the present invention.

FIG. 9 is image information sent corresponding to the external access to the router in accordance with the preferred embodiment of the present invention.

### DESCRIPTION OF THE PREFERRED EMBODIMENT

A preferred embodiment of the present invention is described below with reference to drawings.

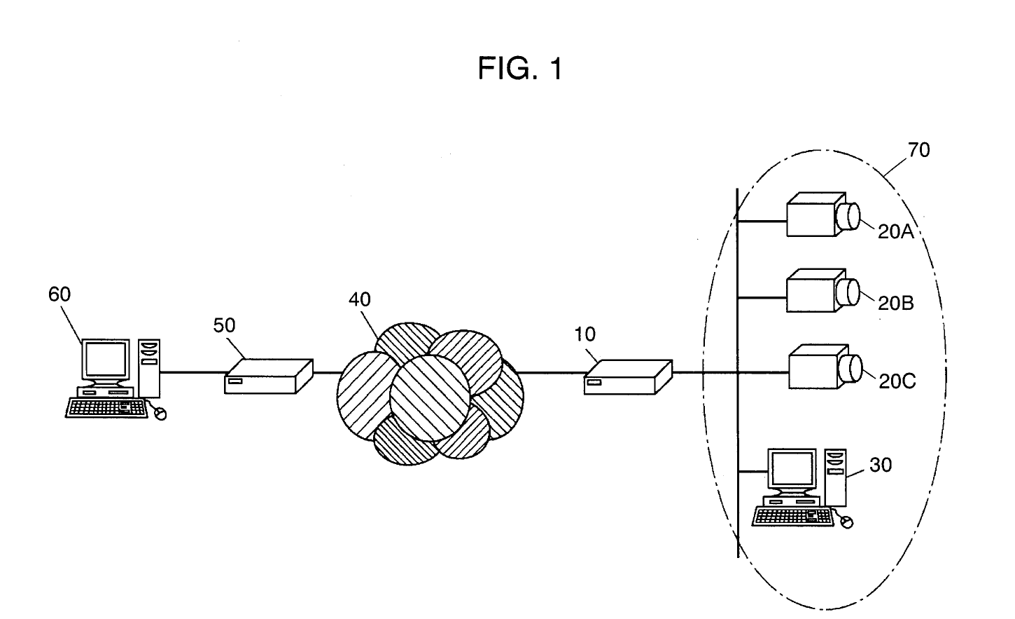

FIG. 1 shows the configuration of a network including router 10. Router 10 is used for connecting external network 40 such as the Internet and private network 70, and relays data to each network. In addition, router 10 automatically sets an IP address and Port No. of a terminal connected to private network 70. Router 10 also has the function of forwarding a transmission packet from the external network such as the Internet to a terminal corresponding to the port designated in the transmission packet.

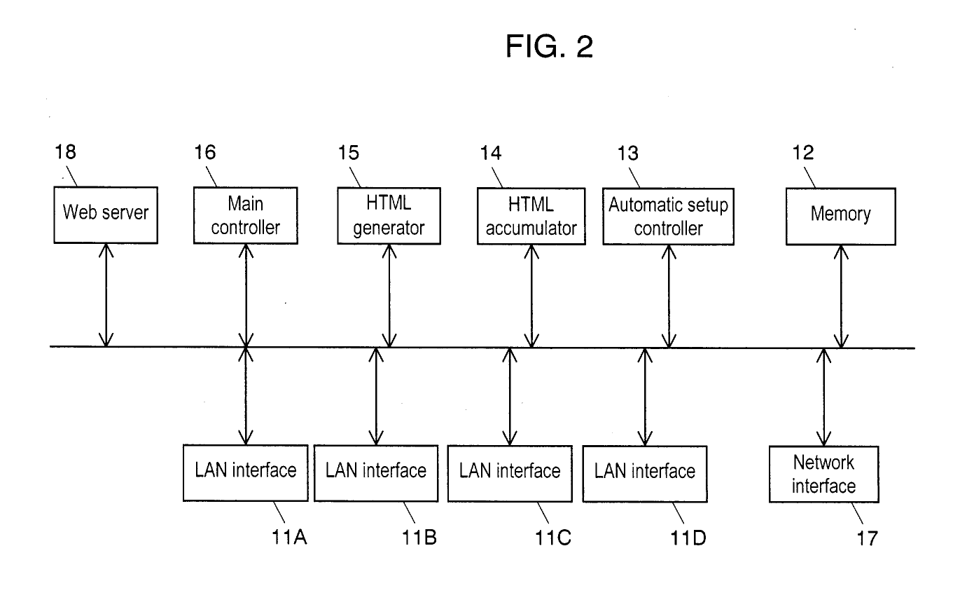

FIG. 2 is a function block diagram illustrating the major functions of router 10 in blocks. Automatic setup controller 13 receives the transmission packet including a MAC address broadcast from image servers 20A to 20C using User Datagram Protocol (UDP) connected to Local Area Network (LAN) interfaces 11A to 11C which can be linked to Ethernet. Then, automatic setup controller 13 automatically sets the IP address, Port No., etc., and stores these set numbers in memory 12. The transmission packet, including the IP address related to the MAC address, received in the UDP is sent to image servers 20A to 20C. Memory 12 relates and stores the MAC address, IP address, Port No., etc. HTML accumulator 14 accumulates HTML data to be sent to an access source when router 10 receives an access from external network 40 without Port No. (or that specifying Port No. 80). HTML generator 15 generates all or a part of the HTML stored in HTML accumulator 14, depending on the setting. Main controller 16 controls the entire router 10. LAN interface 11D is connectable to computer 30, and network interface 17 is connectable to external network 40.

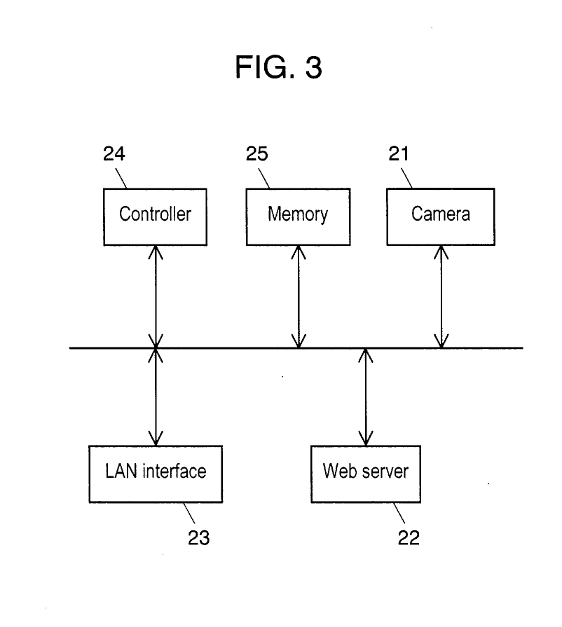

FIG. 3 is a function block diagram illustrating major functions in blocks when terminals consist of image servers, for example. These kinds of terminals are used in the network recently. To simplify description, image server 20 represents image servers 20A to 20C. Image server 20 is typically a network camera, and is connected to private network 70. Image server 20 has camera 21 and web server 22, and is connected to a network through LAN interface 23. Controller 24 controls the entire image server 20. Memory 25 typically stores the transmission packet to be sent to network 70, the setting information such as IP address and Port No. set in network 70, and image data. Image server 20 sends a specified HTML file and image data captured by camera 21 and the like when accessed through network 70. Image server 20 processes image data captured by camera 21 to still image data or motion image data (including motion JPEG), and sends it to the network.

Computer 30 is connected to private network 70. A client computer (PC) 60 is connected to external network 40 through router 50.

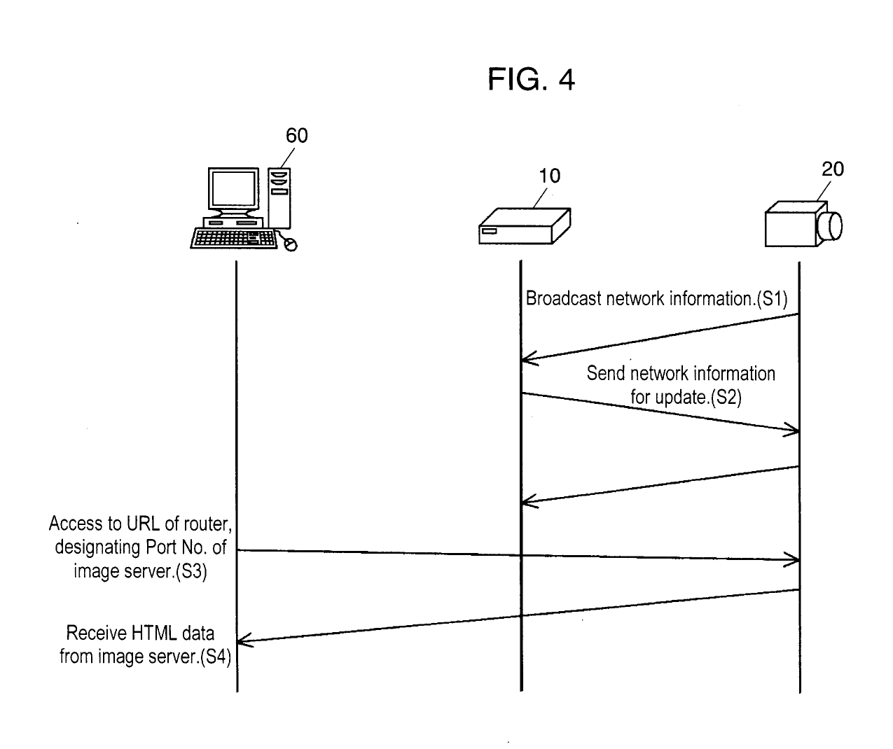

Operation of router 10 and image server 20 as configured above is described next with reference to a sequence chart in FIG. 4.

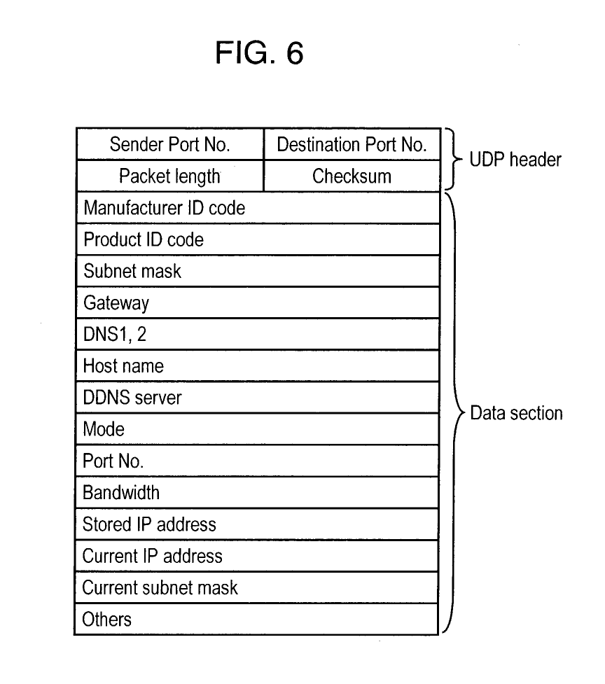

Router 10 operates on private network 70, and image server 20 broadcasts a transmission packet to private network 70 using UDP (S1). This operation repeats at a predetermined time or at a fixed interval when the power is turned on, a reset switch is pressed, or image server 20 is connected to the private network. The transmission packet includes settings for the image server at the point of transmission including the IP address and Port No. The transmission packet consists of UDP header and data section, as shown in FIG. 6. The data section consists of a range of data required for network connection. More specifically, the data section includes a manufacturer identification code for identifying the manufacturer of the image server, the product identification code for identifying the product model of the image server and its version, the IP address set to the image server, subnet mask, DNS server, gateway, and Port No. A destination Port No. in the UDP header uses a number other than well-known Port Nos. 0 to 1023. For example, the destination Port No. may be set to 10667. This destination Port No. 10667 is stored in image server 20 in advance.

Router 10 receives the broadcast transmission packet. When the destination port is identified as predetermined Port No. 10667, router 10 recognizes the transmission packet as a request for automatic setup from image server 20, and begins automatic setup. Automatic setup takes place in the following sequence. First, router 10 checks whether a sender MAC address, included in a data link layer of the transmission packet from image server 20, exists in memory 12. If the sender MAC address does not exist, new setup takes place. If the MAC address and network information corresponding to the MAC address already exist in memory 12, update and checking are carried out.

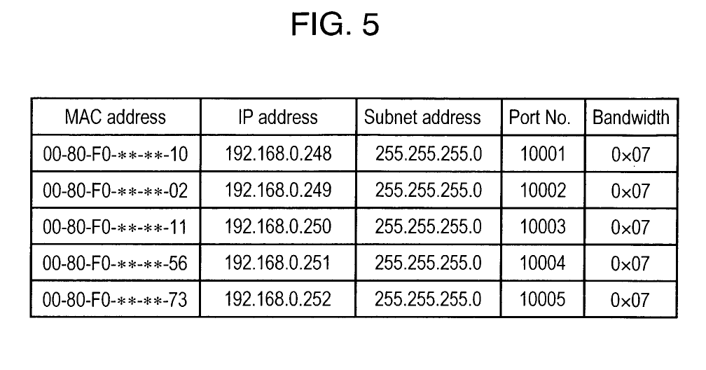

In the new setup, automatic setup controller 13 changes the numbers for IP address, subnet mask, Port No., and bandwidth in the data contained in the data section of the transmission packet received. These are then stored in memory 12 together with other pieces of data. The IP address is changed to a number that is not used in a predetermined range of IP addresses. Subnet mask is changed to a predetermined number. In FIG. 5, the subnet mask is changed to 255.255.255.0. Port No. is changed to a number which is not used in a predetermined range. In this case, it is changed to 10001 to 10005. The bandwidth is changed to a predetermined number. These set numbers are related to the MAC address of each image server, and stored in memory 12. In FIG. 5, the manufacturer identification code and DNS server are omitted to simplify description. The bandwidth is the data transmission rate of the image server for sending data to the network, and is adjustable in response to traffic volume.

Router 10 stores the above numbers in memory 12. Network setup information, including these numbers is then sent as the transmission packet, using UDP, to image server 20 by designating the MAC address stored in memory 12 (S2). The destination port in the UDP header has a number that avoids the use of well-known Port Nos. 0 to 1023 and 10667 (in this case, it is set to 10668). Image server 20 receives the transmission packet broadcast from the router 10. When the image server 20 finds that the destination port is predetermined Port No. 10668, image server 20 recognizes the transmission packet as a response to automatic setup from router 10. Image server 20 then stores the setting information received in its memory 25 and completes automatic setup. If a predetermined time passes after image server 20 broadcasts its transmission packet requesting automatic setup, image server 20 ignores the response transmission packet from the router 10 even if it is sent.

During the update and checking operation, router 10 compares information in the data section of the transmission packet received with information stored in memory 12 (information corresponding to the sender MAC address in the transmission packet). Specific pieces of information compared are IP address, subnet mask, Port No., and bandwidth. If all of the compared pieces are identical respectively, router 10 determines that there is no need for update, and terminates the automatic setup operation. If any of the compared pieces of information is different, information stored in memory 12 (information corresponding to the sender MAC address in the transmission packet) is sent to the sender MAC address using the UDP. The rest of the operation is the same as that for the automatic setup, so description is omitted here.

After the setup, PC 60 connected to an external network such as the Internet accesses to a URL that designates the port of image server 20 (S3). PC 60 designates the global IP address of router 10 and Port No. of image server 20. Router 10 then checks the private network for the presence of image server 20 with the Port No. included in the transmission packet sent from the external network based on information stored in memory 12. If router 10 finds image server 20 with the corresponding Port No., the transmission packet from PC 60 is forwarded to the IP address of image server 20. Image server 20 then receives the forwarded transmission packet. Based on the transmission packet received, image server 20 sends requested HTML data to the sender Port No. of PC 60. PC 60 then receives this HTML data (S4).

In this way, image server 20 broadcasts the automatic setup request together with the setting information at that point, using UDP, when image server 20 is connected to private network 70 to which router 10 is connected. On the other hand, the router 10 analyzes the broadcast transmission packet, and automatically assigns Port No., etc., for the automatic setup. This eliminates the need on the part of the user to set Port No. as well as IP address and subnet mask manually. Accordingly, the private network builder simply needs to connect image server 20 to private network 70 connected to router 10. By this simple operation, a visitor may directly designate and gain access to image server 20 from PC 60 in external network 40 connected to router 10. Even if image server 20 is taken outside the system and the setting information is modified, the original setting can be recovered simply by reconnecting image server 20 to private network 70 connected to router 10. The above describes the case of automatic setup for image server 20. It is apparent that the present invention is applicable to terminals other than image servers as long as terminals are connected to the network and require a setup for connecting to the network.

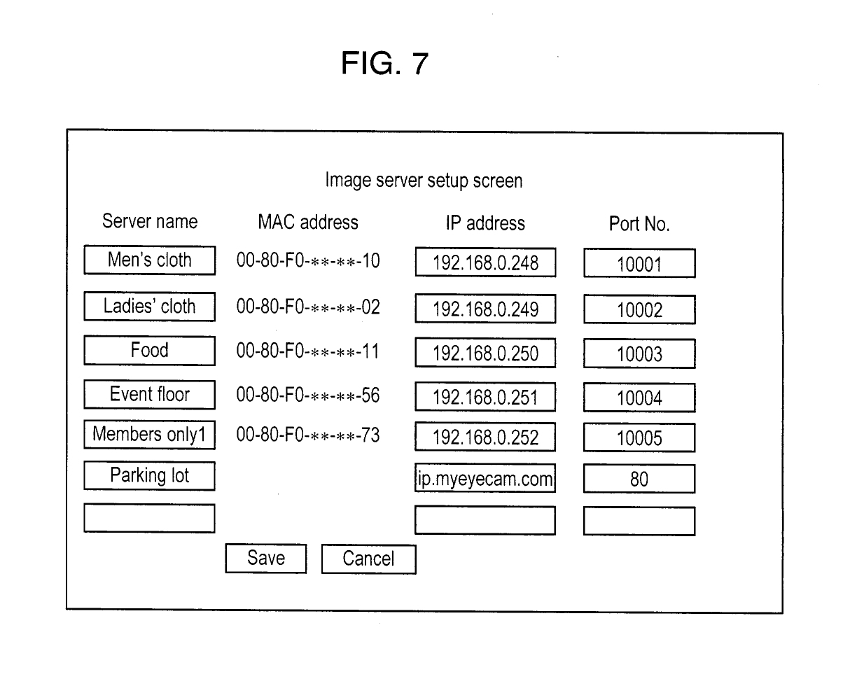

The automatic setup stored in memory 12 can be viewed as an image server setup screen by accessing the IP address of router 10 from computer 30. This screen, shown in FIG. 7, displays the IP address and Port No. of each image server. More specifically, computer 30 accesses the web server function (not illustrated) of router 10 using Port No. 80 of router 10 using Hypertext Transfer Protocol (http). Router 10 then sends HTML data accumulated in HTML accumulator 14 to computer 30 through LAN interface 11D. Here, HTML generator 15 creates the HTML data to be sent. HTML generator 15 retrieves the IP address, Port No., etc. of each of image servers 20A to 20C stored in memory 12, and generates HTML data containing these pieces of information.

Computer 30, after receiving HTML data from router 10, displays the image server setup screen according to the description in the HTML data using its browser (not illustrated). The builder of private network 70 can check the IP address and Port No. of all image servers 20A to 20C by referring to this screen. In addition, IP address and Port No. can be changed using this screen. In other words, the router sends change data to a target image server by inputting a new IP address or Port No. on this screen, and pushing (or clicking) the Save button on the screen. Change data is sent in the same way as the aforementioned automatic setup response from the router.

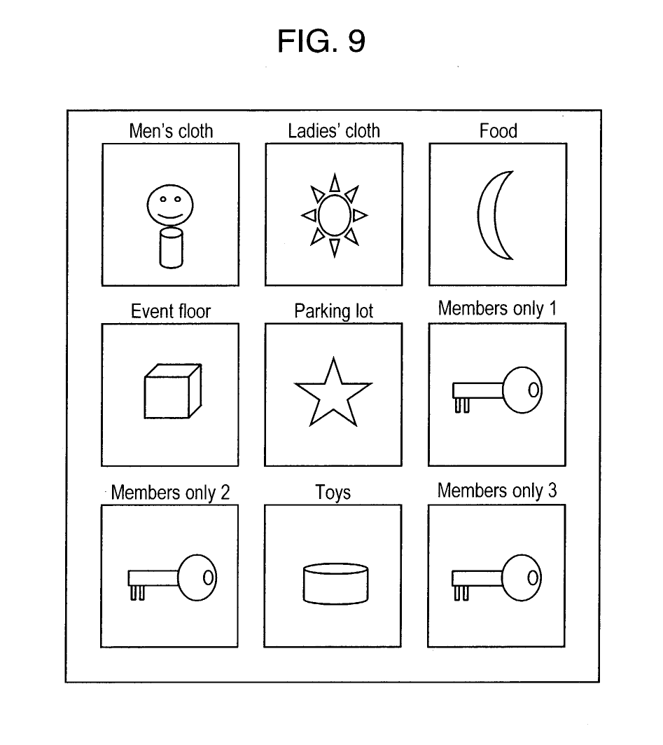

Furthermore, the image server setup screen may be designed to set the name of each image server or set other image servers connected to a network outside the private network, such as the Internet. For example, a server name can be input and registered (by pressing the Save button) using an input device (not illustrated) of computer 30, as shown in FIG. 7. This enables the HTML generator 15 to create a screen displaying the name of each image server corresponding to each image, as shown in FIG. 9.

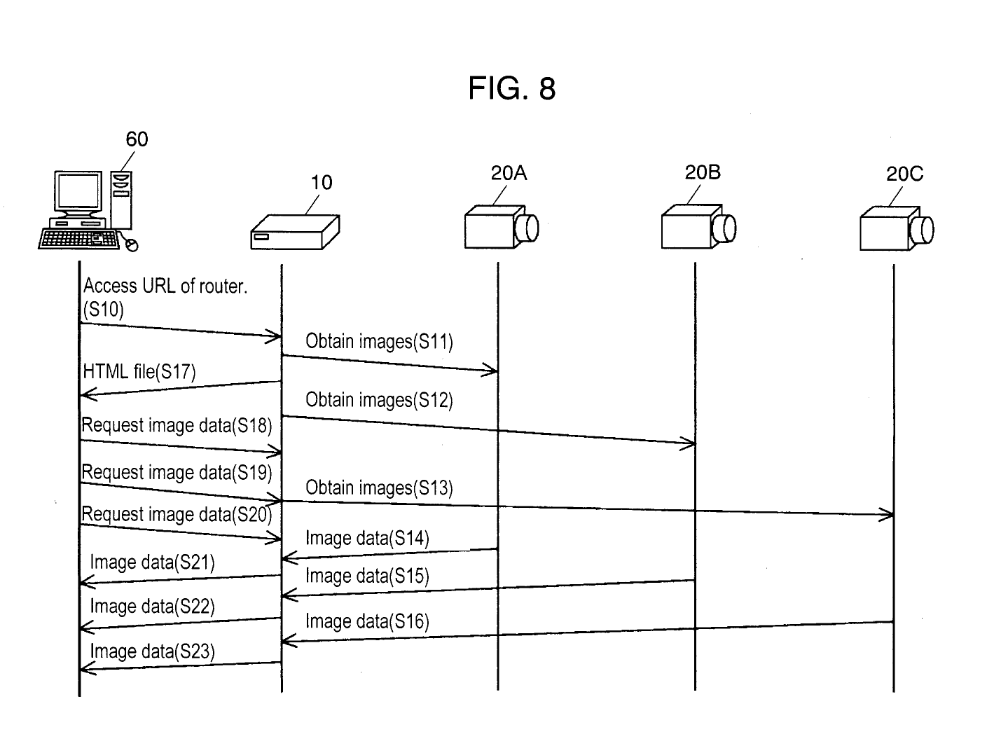

Next, the operation that takes place when PC 60 connected to the external network sends a transmission packet in which the global IP address of router 10 is designated is described with reference to FIG. 8. In this case, the transmission packet does not designate Port No., or uses Port No. 80.

Browser software is installed on PC 60, and the URL of router 10 is designated using this browser software. The transmission packet containing an http message that designates Port No. 80 of router 10 is then sent from PC 60 through external network 40 (S10). Port No. 80 in this case is a Port No. that designates the web server 18 of router 10. Router 10 retrieves the IP addresses of image servers 20A to 20C set in memory 12, and sends the transmission packet for obtaining image data corresponding to each IP address (S11-13). Image servers 20A to 20C receiving this transmission packet send image data at the point of receiving the packet to router 10 which is the sender of the image data transmission packet (S14-16). Router 10 receiving the image data sent stores it in memory 12 after giving it a filename. For example, filenames Jpg1, Jpg2, and Jpg3 are given in this preferred embodiment. When router 10 receives the transmission packet designating router 10 from PC 60, router 10 sends HTML files accumulated in HTML accumulator 14 to the IP address of PC 60 (S17). PC 60 receiving HTML files requests to receive image data of Jpg1, Jpg2, and Jpg3 from a predetermined directory in memory 12 in accordance with the HTML file description (S18-20). Router 10, on receiving this request, sends the requested image data to PC 60 (S21-23). In this way, PC 60 displays each image data from each image server on its screen. Traffic on the private network can be controlled by limiting images from the image servers displayed on the screen to one still image per image server. In particular, the traffic is effectively controlled compared to receiving and displaying images successively from all image servers via direct access to image servers when the image server's default setting is to send motion pictures such as motion JPEGs.

In the above preferred embodiment, router 10 sends the transmission packet to the image server to obtain image data when PC 60 accesses port No. 80 of router 10. It is also possible to make router 10 send the transmission packet that requests sending of image data for obtaining requested image data after PC 60 requests image data Jpg1, Jpg2, and Jpg3.

Accordingly, the image data displayed on the screen is related to each image server name as shown in FIG. 9. In FIG. 9, symbols such as stars are used as images representing each image server for reasons of simplicity. In practical operation, however, images captured by the image server are displayed on the screen. Also in FIG. 9, a key is illustrated as an image indicating image servers for members only 1 to 3. This indicates that an authentication request is sent from the image server in response to an image request from router 10. Data in the image server that requires authentication is not sent unless authentication is confirmed. Therefore, nothing is displayed if no action takes place. This may be confusing for the user of PC 60. To inform the user that authentication is required, a symbol such as a key is displayed instead of an image in the image server requiring authentication. This configuration, in which the need for authentication is announced, enables the user accessing router 10 to understand immediately the need for authentication.

FIG. 9 shows still pictures. For viewing motion pictures, an image displayed for each image server is clicked on the screen of the browser software of PC 60. HTML file of this screen allows a direct access to the image server. When the direct access is established, PC 60 continuously receives images from the image server in real time.

In the above preferred embodiment, router 10 stores image data received from the image server and allows PC 60 to access a memory where image data is stored when PC 60 makes a request to router 10. However, in other cases, the address of each image server and location where images are stored may be described in the HTML file sent from the router to PC 60 when a request is made from PC 60 to router 10. Also in this case, HTML generator 15 creates an HTML file to be sent to PC 60 based on information such as automatic setup information (see FIG. 5) stored in memory 12 of router 10. This enables to complete the image information (web page) to be sent to PC 60 just by connecting the image server to router 10, demonstrating extremely easy operation. Moreover, when server names, etc. are input to the image server setup screen, a web page including the server name which has been input can be automatically completed.

In the prior art, terminals in the external network directly access the image data on each image server. This may result in displaying multiple windows for authentication on the terminal when two or more image servers require authentication, making it difficult for the user to identify which authentication window corresponds to which image server. In the preferred embodiment, router 10 converts a packet containing an authentication request to a predetermined image file (showing an image which announces the need for authentication). This converted image file is sent to PC 60. Consequently, the user of PC 60 receiving this file can easily find out which image server requires authentication.

In the preferred embodiment, a web page shown on a screen, as shown in FIG. 9, is sent and displayed on PC 60 when PC 60 accesses Port No. 80 of router 10. However, this Port No. is not particularly limited. Any number is acceptable as long it is not used in forwarded Port Nos. or other applications. The present invention may also be designed to allow the user to change this Port No. by accessing router 10.

1. A router connected between a private network to which a terminal is connected and an external network, said router:
receiving a transmission packet broadcast from said terminal, said transmission packet containing a MAC address; and
storing network information in which an IP address and Port No. are related to said MAC address, said IP address and Port No. being different from those of other terminal already setup.

2. The router as defined in claim 1, wherein said network information is transmitted by designating said MAC address.

3. The router as defined claim 1, wherein said router forwards said transmission packet to said terminal whose said Port No. stored is same as a Port No. contained in said transmission packet when said transmission packet designating said Port No. of said terminal is received from said external network.

4. A router connected between a private network to which a terminal is connected and an external network, said router comprising:
a first controller for generating an IP address and Port No. on receiving a transmission packet broadcast from said terminal, said transmission packet containing a MAC address; and
a memory for storing said IP address and Port No. as network information related to said MAC address;
wherein said first controller generates said IP address and Port No. different from those of other terminal already stored in said memory.

5. The router as defined in claim 4 further comprising a second controller for sending said network information stored in said memory to said terminal via said private network by designating said MAC address.

6. The router as defined in claim 5, wherein said second controller forwards said transmission packet to said terminal whose Port No. stored in said memory matches a Port No. contained in said transmission packet when said transmission packet designating Port No. of said terminal is received from said external network.

7. The router as defined in claim 1, wherein said router requests for sending an image to said terminal, and sends a received display information containing image data to a computer connected to said external network when said router receives a packet designating Port No. of a web server of said router from said computer.

8. The router as defined in claim 7, wherein said router sends display information, containing image data indicating a need for authentication, to said computer when said terminal to which transmission of an image is requested requires authentication.

9. The router as defined in claim 4 further comprising:
a first interface for linking to said private network; and
a second interface for linking to said external network;
wherein said router outputs said transmission packet via said first interface to said terminal whose Port No. matches a Port No. received from said memory when said transmission packet designating said Port No. of said terminal is received from said external network via said second interface.

10. A network system linked to an external network, said network system comprising:
a terminal which broadcasts a transmission packet containing its own MAC address to a connected network; and
a router which receives said transmission packet broadcast from said terminal, and stores an IP address and Port No. as network information related to said MAC address, said IP address and Port No. being different from those of a terminal already setup.

11. The network system as defined in claim 10, wherein said router requests to said terminal for sending an image, and sends display information including received image data to a computer connected to said external network when said router receives a packet designating Port No. of a web server of said router from said computer.

12. The network system as defined in claim 11, wherein said network system has a plurality of said terminals, said router allows said computer to directly access said terminal corresponding to said image data when said computer displays display information containing image data received and said image data is selected.

13. The network system as defined in claim 11, wherein said router sends display information containing image data indicating a need for authentication to said computer when said terminal requires authentication against a request made by said router to said terminal for sending an image.

14. The network system as defined in claim 10, wherein said terminal broadcasts said transmission packet in one of cases when:
said terminal is turned on;
said terminal is reset; and
said terminal is connected to said network.

15. The network system as defined in claim 10, wherein said terminal has a memory for storing said transmission packet.

16. The network system as defined in claim 15, wherein said memory further stores IP address and Port No. broadcast from said router.

17. A network setup method which assigns an IP address and Port No. to a terminal in a private network to which said terminal and a router are connected; said method comprising:
broadcasting a transmission packet containing a MAC address from said terminal;
receiving said transmission packet by said router; and
storing said IP address and Port No. as network information related to said MAC address by said router, said IP address and Port No. being different from those of other terminal already setup.

18. The network setup method as defined in claim 17 further comprising a step of sending said network information by designating said MAC address.
